(19) United States
(12) Patent Application Publication
(10) Pub. No.: US 2011/0025255 A1
(43) Pub. Date: Feb. 3, 2011

(54) Solar Power System For Charging Battery Pack

(75) Inventors: Takao Aradachi, Hitachinaka-shi (JP); Nobuhiro Takano, Hitachinaka-shi (JP); Kazuhiko Funabashi, Hitachinaka-shi (JP); Chikai Yoshimizu, Hitachinaka-shi (JP); Shigeru Ishikawa, Hitachinaka-shi (JP); Masanori Aoki, Hitachinaka-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Koki Co., Ltd., Minato-ku (JP)

(21) Appl. No.: 12/846,517

(22) Filed: Jul. 29, 2010

(30) Foreign Application Priority Data
Jul. 30, 2009 (JP) JP 2009-177832
Aug. 31, 2009 (JP) JP 2009-199871

(51) Int. Cl. H01M 10/46

(52) U.S. Cl. 320/101

(57) ABSTRACT

A solar power system has a charging device. The charging device is powered by a solar cell to charge a battery pack having a secondary cell. The charging device has input voltage detection circuit that detects an input voltage from the solar cell; switching circuit that converts the input voltage to supply a charging current to the battery pack; charging current detection circuit that detects the charging current; and control circuit that controls the switching circuit to change the input voltage in order that a resultant charging current becomes suitable for charging the battery pack.

### CROSS REFERENCE TO RELATED APPLICATION

This application claims priority from Japanese Patent Application No. 2009-177832 filed Jul. 30, 2009 and Japanese Patent Application No. 2009-199871 filed Aug. 31, 2009. The entire content of each of these priority applications is incorporated herein by reference.

### TECHNICAL FIELD

The present invention relates to a solar power system, in particular a battery charging device powered by a solar cell for charging a battery pack.

### BACKGROUND

Battery charging devices for charging battery packs housing nickel-cadmium batteries or lithium-ion batteries have conventionally been powered with a commercial power supply. However, when a power tool connected to such a battery pack is operated over an extended period of time at a site having no such commercial power supply, the operator must arrange to have a sufficient number of spare battery packs necessary for completing the workload. Therefore, there is a need for a charging device for charging battery packs that does not rely on a commercial power supply. One charging device proposed for this purpose is provided with a plurality of converters for voltage conversion. By selecting a converter suited to the available power supply, the charging device can charge the battery pack using power from one of two or more types of power supplies.

A solar cell is one example of a noncommercial power supply. However, solar cells can be problematic because their output power fluctuates considerably according to the amount of available sunlight. That is, the output power increases when the sunlight irradiance is great and decreases when the irradiance is small. The output power can also vary when the irradiance stays the same due to variations in the output voltage, operating temperature, and the like. In order to maximize usage of output power from a solar cell under such conditions, the charging device is often provided with a microcomputer and the like to perform complex operations. However, providing a charging device with a microcomputer capable of complex operations is not cost-efficient.

### SUMMARY

Therefore, it is an object of the present invention to provide a charging device that can be powered by a solar cell and that is capable of efficiently charging a battery pack through a simple construction.

The present invention features a solar power system having a charging device. The charging device is powered by a solar cell to charge a battery pack having a secondary cell. The charging device has input voltage detection circuit that detects an input voltage from the solar cell; switching circuit that converts the input voltage to supply a charging current to the battery pack; charging current detection circuit that detects the charging current; and control circuit that controls the switching circuit to change the input voltage in order that a resultant charging current becomes suitable for charging the battery pack.

### BRIEF DESCRIPTION OF THE DRAWINGS

The particular features and advantages of the invention as well as other objects will become apparent from the following description taken in connection with the accompanying drawings, in which:

FIG. 1 is a graph showing a relationship among output voltage V, output current I, and output power from a solar cell, depending on irradiance thereon;

FIG. 2 is a graph showing a relationship between output voltage V and output current I from a solar cell, depending on a temperature thereof;

FIG. 3 is a graph showing a relationship between output voltage V and output current I from a solar cell, depending on irradiance thereon;

FIG. 4 is a circuit diagram showing a charging device according to the first embodiment of the present invention;

FIG. 5 is a flowchart for charging a battery pack with output power from a solar cell;

FIG. 6 is another flowchart for charging a battery pack with output power from a solar cell;

FIG. 7 is a table showing a relationship between a battery temperature and a limit current by a method for charging a battery pack with a solar cell according to the present invention;

FIG. 8 is a circuit diagram showing a charging device according to the second embodiment of the present invention;

FIG. 9 is a block diagram showing a radio powered by a battery pack according to the present invention;

FIG. 10 is a flowchart for charging a battery pack according to the present invention;

FIG. 11 is a circuit diagram showing a charging device according to a variation of the second embodiment of the present invention; and

FIG. 12 is a block diagram showing a radio powered by a battery pack according to the present invention.

### DETAILED DESCRIPTION

Next, embodiments of the present invention will be described while referring to the accompanying drawings. First, the output characteristics of a solar cell serving as the power source for the charging device of the present invention will be described. A solar cell is a device that generates electricity from sunlight using the photovoltaic effect of a semiconductor such as silicon (Si).

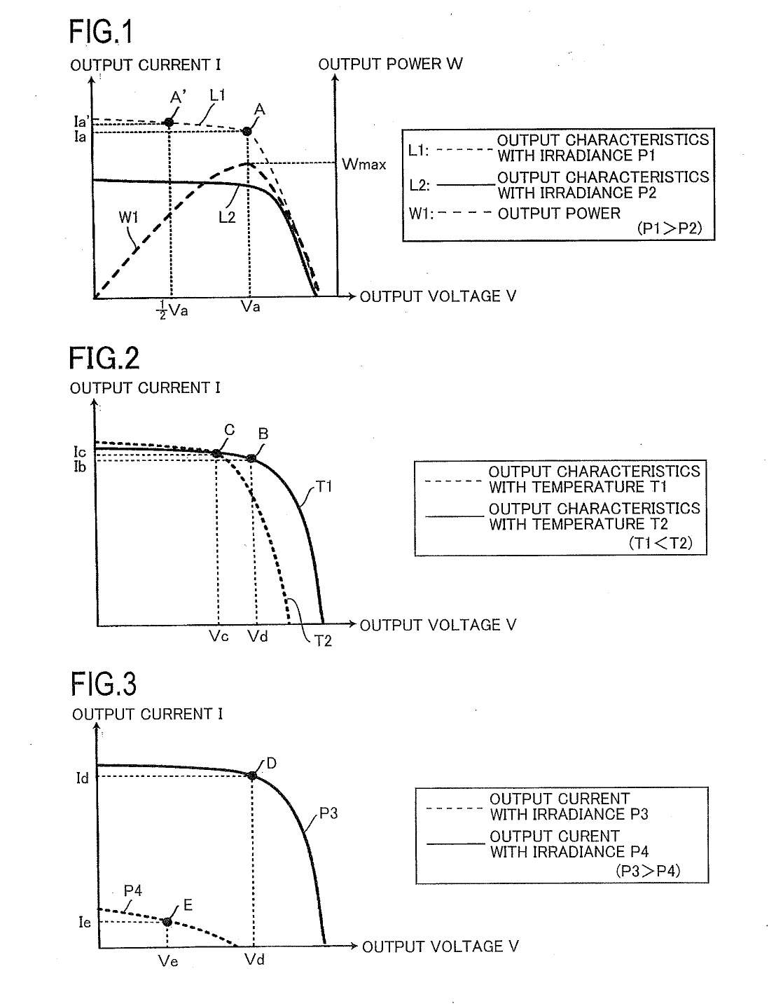

FIG. 1 illustrates an example of how output characteristics of a solar cell are dependent on input solar irradiance, where the horizontal axis represents the output voltage of the solar cell and the vertical axis represents the output current and output power. In the example of FIG. 1, an irradiance P1 is greater than an irradiance P2; that is, the irradiance P1 indicates that a larger quantity of the sun's rays are incident on the solar cell. As shown in FIG. 1, the output characteristics of the solar cell vary according to the irradiance. Specifically, the output power is greater for a larger irradiance, such as the irradiance P1, and lesser for a smaller irradiance, such as the irradiance P2. The line L1 in FIG. 1 indicates changes in output power in response to the output voltage for the case of the irradiance P1. Thus, even though the irradiance stays the same, the output power varies according to the output voltage. This phenomenon will be described next using FIG. 1.

When the solar cell is used at point A in FIG. 1 under the irradiance P1, power is equivalent to voltage×current. Accordingly, if the voltage at point A is Va and the current Ia, the output power is equivalent to Va×Ia. Next, lets consider use of the solar cell at point A′. The voltage at point A′ is 1/2 Va, but there is little change in current between points A and A′. Therefore, the current Ia′ at point A′ is substantially equivalent to the current Ia at point A. Thus, the output power at point A′ is equivalent to ½ Va×Ia. In other words, the output at point A′ is one-half the output power at point A. This phenomenon occurs for any irradiance above a certain quantity, such as for the irradiance P2 (where P1>P2) at the same temperature.

The point at which output power W1 is the maximum value under the irradiance P1 (Wmax in the example of FIG. 1), for example, is a point on the output characteristic curve for the irradiance P1 from which a vertical line drawn to the horizontal axis representing voltage and a horizontal line drawn to the vertical axis representing current form a rectangle with the horizontal and vertical axes that has the maximum area. The area of this rectangle is equivalent to the horizontal axis (voltage)×the vertical axis (current)=power. Hereinafter, this point will be referred to as the maximum operating point.

Here, charging of a secondary battery directly connected to a solar cell will be considered. In such a case, the output voltage of the solar cell must be approximately the same as the voltage of the secondary cells. When a solar cell having the characteristics shown in FIG. 1 is directly connected to a secondary battery having a rated voltage of ½ Va, the output voltage of the solar cell must also be approximately ½ Va. Under these conditions, the charging current is Ia for the irradiance P1. Since the maximum output power is Va×Ia, as described above, when directly connected to the solar cell, the secondary battery can only draw power equivalent to ½ Va×Ia from the solar cell.

However, it is possible to provide a switching circuit between the solar cell and secondary battery to maintain the voltage of the solar cell at a prescribed value. By maintaining the output voltage from the solar cell at Va, a power equivalent to Va×Ia can be produced under the irradiance P1, as described above. Thus, when charging a secondary battery having a voltage of ½ Va, for example, the charging current is calculated as follows. Since output power=efficiency×input power, output voltage×output current is equivalent to efficiency×input voltage×input current. Assuming an efficiency of 85%, for example, with an output voltage of ½ Va, an input voltage of Va, and an input current of Ia, ½ Va×output current=0.85×Va×Ia. Hence, output current=2×0.85Ia=1.7Ia. In other words, the secondary battery can be charged with a charging current approximately 1.7 times that when the secondary battery is directly connected to the solar cell.

As described above, the voltage at the maximum operating point of the solar cell roughly approaches the same value for irradiances above a certain level, such as the irradiances P1 and P2 in FIG. 1, under the same temperature conditions. However, the voltage drops under high temperatures, as shown in the example of FIG. 2, shifting the maximum operating point by a significant amount. In the example of FIG. 2, the output characteristics for a temperature T1 are indicated by the solid line, where the maximum operating point is a point B having an output voltage Vb and an output current Ib. The output characteristics under a temperature T2 higher than the temperature T1 are indicated by the dotted line, where the maximum operating point is a point C having an output voltage Vc and an output current Ic.

As shown in FIG. 3, the maximum operating point also shifts considerably when the irradiance on the solar cell drops. In this example, the operating characteristics under an irradiance P3 are indicated by the solid line, where the maximum operating point is a point D having an output voltage Vd and an output current Id. The output characteristics under an irradiance P4 lower than the irradiance P3 are indicated by a dotted line, where the maximum operating point is a point E having an output voltage Ve and an output current Ie.

In order to extract the maximum power from the solar cell under the above varied conditions, it is necessary to perform complex operations with a microcomputer or the like. However, a high-performance microcomputer capable of executing such complex operations is problematic due to its high cost, for example. The charging device according to the present embodiment is configured so as not to require a high-performance microcomputer.

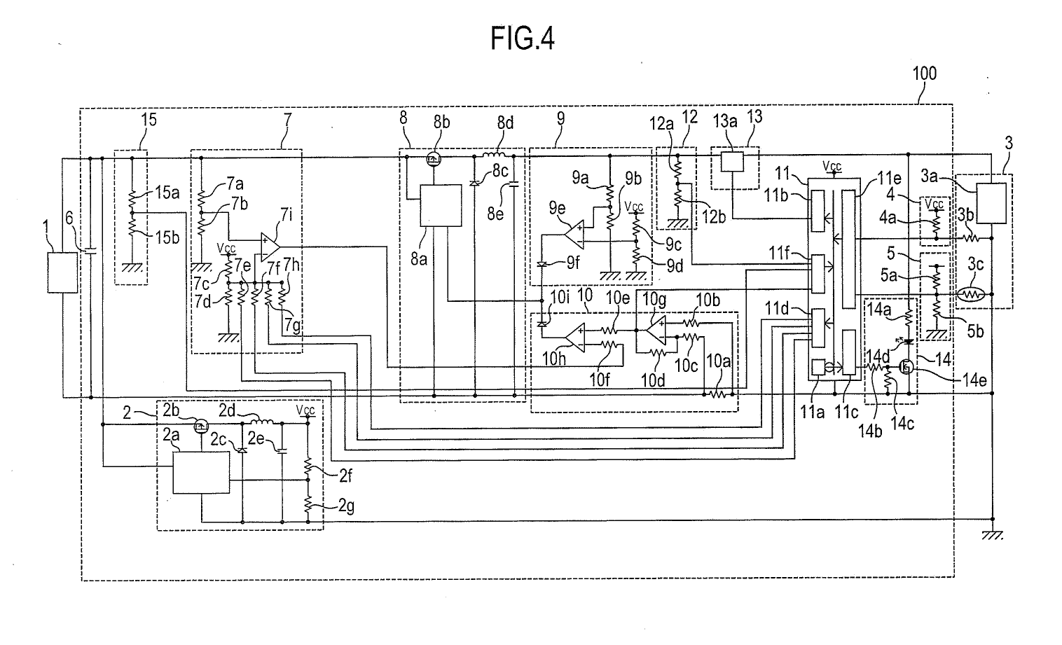

FIG. 4 shows a charging device 100 according to a first embodiment of the present invention. The charging device 100 uses a solar cell 1 as a power source for charging a battery pack 3.

The battery pack 3 is configured of a cell module 3a having one or more battery cells; a battery type discrimination resistor 3b for identifying the type of the cell module 3a, the number of cells therein, or the like; and a temperature-sensitive resistor 3c configured of a thermistor or the like placed in proximity to the cell module 3a for monitoring the battery temperature. The battery cells are secondary batteries, such as lithium-ion batteries, nickel-metal hydride batteries, or nickel-cadmium batteries. The cell module 3a is configured of one or more such battery cells connected in parallel or series. The resistance value of the battery type discrimination resistor 3b corresponds to the type of battery cells or their rated voltage; the output voltage of the batteries, such as 14.4 V or 18 V; the connection format, i.e., parallel or series; or the number of cells connected in series, such as four cells or five cells.

The solar cell 1 is a power supply that generates electricity from incident light. The solar cell 1 may be detachably assembled to the charging device 100. The charging device 100 includes a smoothing capacitor 6 and a power supply switching circuit 8 and functions to output electrical power for charging the battery pack 3. The charging device 100 also has an input voltage detection circuit 15, an input voltage feedback circuit 7, a charging voltage feedback circuit 9, a charging current feedback circuit 10, a microcomputer 11, an auxiliary power supply 2, a battery type discrimination circuit 4, a battery temperature detection circuit 5, a battery voltage detection circuit 12, and a charging on/off circuit 13. The charging device 100 functions to control charging power.

The smoothing capacitor 6 functions to suppress fluctuations in output from the solar cell 1. The power supply switching circuit 8 functions to control the charging voltage and charging current. The power supply switching circuit 8 is configured of a DC/DC converter 8a, a P-channel FET 8b, a rectifier diode 8c, a coil 8d, and a smoothing capacitor 8e. In this embodiment, the power supply switching circuit 8 functions to step down the voltage outputted from the solar cell to produce a charging voltage. The DC/DC converter 8a is connected to the gate of the P-channel FET 8b for stepping down output from the smoothing capacitor 6. Feedback signals outputted from the charging voltage feedback circuit 9 and charging current feedback circuit 10 are inputted into the DC/DC converter 8a. The DC/DC converter 8a controls the timing for switching the P-channel FET 8b based on the feedback signals in order to control the charging current and charging voltage. The source of the P-channel FET 8b is connected to the positive side of the solar cell 1. The rectifier diode 8c is connected between the drain of the DC/DC converter 8a and the negative side of the solar cell 1. The input terminal of the coil 8d is connected to the drain of the P-channel FET 8b. The smoothing capacitor 8e is connected between the output terminal of the coil 8d and the negative side of the solar cell 1 for suppressing fluctuations in output from the DC/DC converter 8a.

The input voltage detection circuit 15 is connected to the positive side of the solar cell 1 and functions to detect an input voltage therefrom. The input voltage detection circuit 15 includes resistors 15a and 15b connected in series. The resistors 15a and 15b function to divide the input voltage. Since the voltage resulting from this division is inputted into an A/D port 1f of the microcomputer 11 described later, the microcomputer 11 can detect the input voltage.

The input voltage feedback circuit 7 is configured of resistors 7a, 7b, 7c, 7d, 7e, 7f, 7g, and 7h and an operational amplifier (op-amp) 7i. The resistors 7a and 7b are connected in series and function to divide the output voltage from the solar cell 1, with the resulting voltage being inputted into the noninverting input terminal of the op-amp 7i. The resistors 7c and 7d are also connected in series and function to divide a voltage Vcc, with the resultant value being inputted into the inverting input terminal of the op-amp 7i as a voltage setting for maintaining the input voltage at a prescribed value. This voltage will be referred to as a first voltage setting V1.

One end of each of the resistors 7e, 7f, 7g, and 7h is connected to the connecting point between the resistors 7c and 7d, while the other end is connected to an output port 11d of the microcomputer 11 described later. By outputting a LOW signal from the output port 11d of the microcomputer 11 to the resistor 7e, for example, it is possible to set the value inputted into the inverting input terminal of the op-amp 7i to the voltage Vcc divided by the resistor 7c and the parallel resistance of the resistors 7d and 7e. This voltage will be referred to as a second voltage setting V2 that differs from the first voltage setting V1 described earlier.

Similarly, by outputting a LOW signal from the output port 11d of the microcomputer 11 to the resistor 7f, the value inputted into the inverting input terminal of the op-amp 7i can be set to the value of the voltage Vcc divided by the resistor 7c and the parallel resistance of the resistors 7d and 7f. This value will be referred to as a third voltage setting V3. Similarly, by outputting a LOW signal from the output port 11d of the microcomputer 11 to the resistor 7g, the value inputted into the inverting input terminal of the op-amp 7i can be set to the value of the voltage Vcc divided by the resistor 7c and the parallel resistance of the resistors 7d and 7g. This value will be referred to as a fourth voltage setting V4. Similarly, by outputting a LOW signal from the output port 11d of the microcomputer 11 to the resistor 7h, the value inputted into the inverting input terminal of the op-amp 7i can be set to the value of the voltage Vcc divided by the resistor 7c and the parallel resistance of the resistors 7d and 7h. This value will be referred to as a fifth voltage setting V5. The first through fifth voltage settings are each different from one another.

The output voltage from the solar cell 1 is controlled based on the output signal from the op-amp 7i at the voltage setting corresponding to the output signal from the microcomputer 11. The voltage settings are set to values capable of producing an output power from the solar cell 1 that approaches the maximum power.

The charging voltage feedback circuit 9 is configured of resistors 9a, 9b, 9c, and 9d; an op-amp 9e; and a diode 9f. The resistors 9a and 9b divide the output voltage from the power supply switching circuit 8, i.e., the charging voltage, with the resultant voltage being inputted into the noninverting input terminal of the op-amp 9e. The resistors 9c and 9d divide a voltage Vcc, with the resultant voltage being inputted into the inverting input terminal of the op-amp 9e as a charging voltage setting designed to maintain the charging voltage at a prescribed value. The op-amp 9e outputs a signal corresponding to the difference between the charging voltage divided by the resistors 9a and 9b and the charging voltage setting for dividing the voltage Vcc with the resistors 9c and 9d. The DC/DC converter 8a controls the charging voltage by switching the P-channel FET 8b based on the output signal from the op-amp 9e. Since the diode 9f is connected in series to the output terminal of the op-amp 9e, the charging voltage setting actually serves as a limiting voltage above which the battery voltage cannot be raised. In this way, the DC/DC converter 8a maintains the charging voltage at a prescribed value by switching the P-channel FET 8b to raise the voltage when the voltage has dropped below the charging voltage setting and switching the P-channel FET 8b to lower the voltage when the voltage has risen above the this setting.

The charging current feedback circuit 10 is configured of a shunt 10a; resistors 10b, 10c, 10d, 10e, and 10f; op-amps 10g and 10h; and a diode 10i. When an electric current flows through the shunt 10a, a negative potential equivalent to the electric current×shunt resistance×(−1) is inputted into the noninverting input terminal of the op-amp 10g. The op-amp 10g and the resistors 10b, 10c, and 10d constitute an inverting amplifier circuit. The value of a negative potential proportional to the charging current multiplied by 10d/10c is inputted into the noninverting input terminal of the op-amp 10g and outputted from the output terminal of the op-amp 10g. The outputted value is subsequently inputted into the noninverting input terminal of the op-amp 10h. In the meantime, output from the op-amp 7i, which is a feedback signal from the input voltage feedback circuit 7, is inputted into the inverting input terminal of the op-amp 10h. The op-amp 10h outputs a current control signal corresponding to the charging current flowing through the shunt 10a and the output from the input voltage feedback circuit 7 to control the charging current by controlling the DC/DC converter 8a to switch the P-channel FET 8b. Since the diode 10i is connected to the output terminal of the op-amp 10h in series, the current control signal actually functions as a signal for preventing the charging current from being raised above a prescribed value.

Here, we will consider a case in which the input voltage (voltage from the solar cell 1) rises above the input voltage setting set in the input voltage feedback circuit 7. In this embodiment, the power supply switching circuit 8 controls the charging voltage and charging current based on feedback signals outputted from the op-amps 9e and 10h. In other words, the power supply switching circuit 8 performs switching control so that the potentials of the noninverting input terminals and inverting input terminals of the op-amps 9e and 10h are the same (a virtual short circuit). When the input voltage rises, equilibrium is lost on the input side of the op-amp 7i.

Further, since the output of the op-amp 7i is inputted into the input terminal of the op-amp 10h in the charging current feedback circuit 10, equilibrium is lost on the input side of the op-amp 10h. Consequently, the power supply switching circuit 8 performs switching based on the feedback signal from the op-amp 10h to establish equilibrium on the inputs of the op-amps 7i and 10h. This switching raises the charging current to a value that reduces the input voltage to the input voltage setting.

Conversely, when the input voltage (voltage from the solar cell 1) falls below the input voltage setting set in the input voltage feedback circuit 7, the power supply switching circuit 8 reduces the charging current to a value that raises the input voltage to the input voltage setting. In other words, when irradiance increases, increasing the voltage outputted by the solar cell, the charging current is raised. Conversely, when irradiance decreases, decreasing the voltage from the solar cell 1, the charging current is reduced. Through this control, the power supply switching circuit 8 maintains the battery voltage from the solar cell at a prescribed value.

The microcomputer 11 includes a CPU 11a; output ports 11b, 11c, and 11d; and A/D ports 11e and 11f. The microcomputer 11 functions to control operations of the charging device 100.

The battery voltage detection circuit 12 is configured of resistors 12a and 12b. The resistors 12a and 12b divide the battery voltage with the resultant voltage being inputted into the A/D port 11f of the microcomputer 11.

The charging on/off circuit 13 includes a resistor 13a. The charging on/off circuit 13 turns charging on or off based on a signal inputted from the output port 11b of the microcomputer 11 into the resistor 13a. To perform charging, the output port 11b of the microcomputer 11 outputs a HIGH signal, for example, to the charging on/off circuit 13, connecting the charging device 100 to the cell module 3a. To halt charging, the output port 11b of the microcomputer 11 outputs a LOW signal, for example, to disconnect the charging device 100 from the cell module 3a.

The battery type discrimination circuit 4 is configured of a resistor 4a and functions to determine the type of the battery pack 3. More specifically, the microcomputer 11 determines the type of battery based on the value of the voltage Vcc divided by the resistor 4a and the battery type discrimination resistor 3b provided in the battery pack 3 inputted into the A/D port 11e of the microcomputer 11. The battery type must be determined because the method of controlling charging differs according to the type of battery. It is necessary to perform charging that is suited to the battery type.

The battery temperature detection circuit 5 is configured of resistors 5a and 5b and functions to measure the temperature of the cell module 3a. The microcomputer 11 detects the battery temperature based on the value of the voltage Vcc divided by the resistor 5a and the parallel resistance of the resistor 5b and temperature-sensitive resistor 3c inputted into the A/D port 11e of the microcomputer 11. The temperature-sensitive resistor 3c is a temperature-sensitive element whose resistance value changes according to the battery temperature in the battery pack 3.

The charging device 100 also includes a charging status indicator circuit 14 for notifying the user when charging is being performed. The charging status indicator circuit 14 is configured of resistors 14a, 14b, and 14c; an LED 14d; and an FET 14e. During a charging operation, the output port 11c of the microcomputer 11 outputs a HIGH signal to the resistor 14b. The HIGH signal turns on the FET 14e, lighting the LED 14d. When a charging operation is not being performed, the output port 11c outputs a LOW signal, turning off the FET 14e and extinguishing the LED 14d.

The auxiliary power supply 2 supplies power to the microcomputer 11 and the op-amps. The auxiliary power supply 2 is configured of a DC/DC converter 2a, a P-channel FET 2b, a rectifier diode 2c, a coil 2d, a smoothing capacitor 2e, and resistors 2f and 2g. In this embodiment, the auxiliary power supply 2 steps down the output voltage from the solar cell 1, generating a voltage Vcc that serves as a power supply for the microcomputer 11 and the like. The DC/DC converter 2a steps down output from the smoothing capacitor 6. The DC/DC converter 2a switches the P-channel FET 2b so that the output voltage divided by the resistors 2f and 2g becomes a prescribed value set in the DC/DC converter 2a.

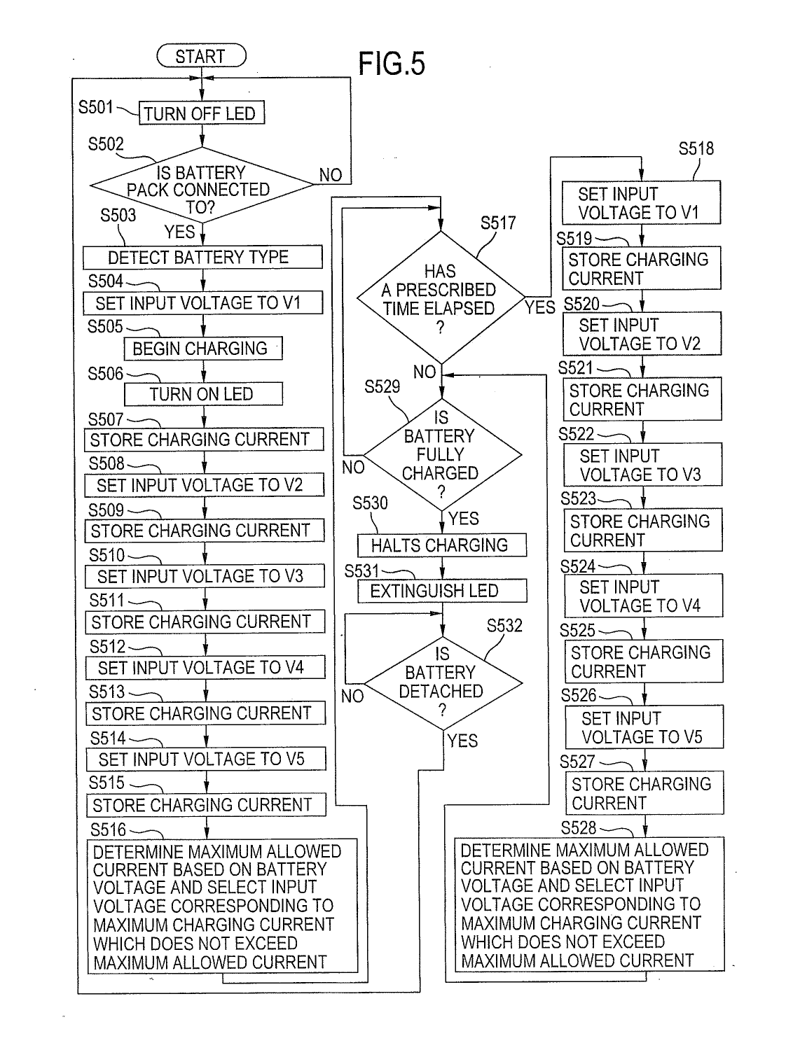

Next, operations of the charging device 100 will be described with reference to FIGS. 4 and 5.

Since the solar cell 1 supplies power to the auxiliary power supply 2, the auxiliary power supply 2 supplies power to the microcomputer 11 when the solar cell 1 is connected to the charging device 100, placing the microcomputer 11 in an operating state. Prior to connecting a battery to the charging device 100, in Step (hereinafter “Step” will be abbreviated as “S”) 501 the LED 14d is turned off to notify the user that charging is not being performed. In order to turn off the LED 14d, the output port 11c of the microcomputer 11 outputs a LOW signal to the resistor 14b, turning off the FET 14e.

In S502 the microcomputer 11 determines whether a battery pack 3 has been connected to the charging device 100. This connection may be determined based on a change in the detection signal inputted by the battery temperature detection circuit 5 into the A/D port 11e of the microcomputer 11, for example. In S503 the microcomputer 11 determines the type of battery based on a detection signal from the battery type discrimination circuit 4.

In S504 prior to beginning a charging operation, the input voltage is set to the first voltage setting V1. As described above, the microcomputer 11 sets the input voltage to the first voltage setting V1 using the resistors 7c and 7d by not outputting a signal from the output port 11d to any of the resistors 7e-7h.

In S505 the microcomputer 11 begins charging. Specifically, the microcomputer 11 begins charging by outputting a signal from the output port 11b to the resistor 13a. In S506 the microcomputer 11 turns on the LED 14d of the charging status indicator circuit 14 in order to notify the user that charging has begun. In order to light the LED 14d, the output port 11c of the microcomputer 11 outputs a HIGH signal to the resistor 14b, turning on the FET 14e.

The charging device 100 of this embodiment can modify the input voltage based on the input voltage feedback circuit 7.

In S507 the microcomputer 11 detects and stores the value of the charging current based on the value outputted from the output terminal of the op-amp 10g and the like when charging was initiated in S505 and received by the A/D port 11f of the microcomputer 11. Next, in S508 the microcomputer 11 changes the input voltage to the second voltage setting V2. The microcomputer 11 sets the second voltage setting V2 using the resistor 7c and the parallel resistance of the resistors 7d and 7e by outputting a LOW signal from the output port 11d to the resistor 7e. In S509 the microcomputer 11 detects and stores the value of the charging current at this time based on the value outputted from the output terminal of the op-amp 10g and received by the A/D port 11f.

In S510 the microcomputer 11 changes the input voltage to the third voltage setting V3. The microcomputer 11 sets the third voltage setting V3 according to the resistor 7c and the parallel resistance of the resistors 7d and 7f by outputting a LOW signal from the output port 11d to the resistor 7f. In S511 the microcomputer 11 detects and stores the value of the charging current at this time based on the value outputted from the output terminal of the op-amp 10g and received by the A/D port 11f.

In S512 the microcomputer 11 changes the input voltage to the fourth voltage setting V4. The microcomputer 11 sets the fourth voltage setting V4 according to the resistor 7c and the parallel resistance of the resistors 7d and 7g by outputting a LOW signal from the output port 11d to the resistor 7g. In S513 the microcomputer 11 detects and stores the value of the charging current at this time based on the value outputted from the output terminal of the op-amp 10g and received by the A/D port 11f.

In S514 the microcomputer 11 changes the input voltage to the fifth voltage setting V5. The microcomputer 11 sets the fifth voltage setting V5 according to the resistor 7c and the parallel resistance of the resistors 7d and 7h by outputting a LOW signal from the output port 11d to the resistor 7h. In S515 the microcomputer 11 detects and stores the value of the charging current at this time based on the value outputted from the output terminal of the op-amp 10g and received by the A/D port 11f.

In S516 the microcomputer 11 finds the maximum allowed current of the battery cells based on the battery voltage of the battery pack 3, selects the maximum charging current among the values detected and stored in S507, S509, S511, S513, and S515 within a range that does not exceed this maximum allowed current, and sets an input voltage corresponding to the selected charging current as the voltage setting. Thus, the output port 11d of the microcomputer 11 outputs a LOW signal to the corresponding resistor in order to produce the voltage setting determined in S516. Through the process of S507-S516 described above, the microcomputer 11 can easily find the output voltage of the solar cell 1 (i.e., the input voltage for the charging device 100) that produces the maximum charging current for the battery voltage.

In S517 the microcomputer 11 determines whether a prescribed time has elapsed since charging began. If it is determined in S517 that the prescribed time has elapsed, in S518-S527 the microcomputer 11 sequentially changes the input voltage to V1-V5 and detects and stores the charging current for each input voltage, as performed earlier in S504 and S507-S515. In S528, as described earlier in S516, the microcomputer 11 selects the maximum charging current among the values stored above within a range that does not exceed the maximum allowed current based on the battery voltage of the battery pack 3, and sets the input voltage corresponding to the selected charging current as the voltage setting. By repeatedly performing the above process at prescribed intervals, the battery pack 3 can be more efficiently charged with the maximum power that can be produced from the solar cell 1.

In S529 the microcomputer 11 determines whether the battery pack 3 is fully charged. The method of determining whether the battery pack 3 has a full charge may vary according to the type of battery cell. If the battery pack 3 houses lithium-ion batteries, for example, the microcomputer 11 determines that the battery pack 3 is fully charged when the battery voltage detected by the battery voltage detection circuit 12 reaches a prescribed value. The prescribed value for determining when the battery pack 3 is fully charged may be found based on the battery type detected in S503. For example, when the battery pack 3 is configured of four cells connected in series, the prescribed value is 4 (cells)×4.2 V=16.8 V. When there are five cells connected in series, the prescribed value is 5 (cells)×4.2 V=21 V. Hence, the prescribed value can be set based on 4.2 V per cell. However, the prescribed value is not limited to the value in this example.

If the battery pack 3 houses nickel-cadmium batteries, the microcomputer 11 determines that the battery pack 3 is fully charged when the battery temperature during charging reaches a prescribed value. However, the methods given above for detecting when the battery pack 3 is fully charged are merely examples, and a different method may be used.

If the microcomputer 11 determines in S529 that the battery pack 3 is fully charged, in S530 the microcomputer 11 halts charging. However, if the microcomputer 11 determines in S529 that the battery pack 3 is not yet fully charged, the microcomputer 11 returns to S517. The microcomputer 11 ends charging by outputting a signal from the output port 11b to the resistor 13a. After charging has been halted in S530, in S531 the microcomputer 11 extinguishes the LED 14d in order to notify the user that charging has ended. Specifically, the microcomputer 11 outputs a LOW signal from the output port 11b to the resistor 14b for turning off the FET 14e, and thereby extinguishing the LED 14d.

In S532 the microcomputer 11 determines whether the battery pack 3 has been detached from the charging device 100, returning to S501 when the battery pack 3 is detached. In the process described above, the microcomputer 11 varies the input voltage of the microcomputer 11 at prescribed intervals, detecting and storing the charging current for each input voltage. By setting the input voltage to the value that produced the maximum charging current, the microcomputer 11 can easily detect the output voltage of the solar cell producing the maximum charging current. Hence, the charging device 100 can charge the battery pack 3 with greater efficiency.

In the charging device 100 according to the first embodiment described above, the microcomputer 11 sequentially sets the charging voltage to each of different voltage settings V1-V5 by either not outputting a LOW signal to the input voltage feedback circuit 7, or outputting a LOW signal to one of the resistors 7e-7h. In addition, the microcomputer 11 measures and stores the charging current corresponding to each of these voltages and selects the largest charging current within a range that does not exceed the maximum allowed current for the battery voltage of the battery pack 3. Accordingly, the microcomputer 11 sets the input voltage of the solar cell 1 during charging to a voltage setting corresponding to this charging current. By repeating this setting process at prescribed intervals, power generated by the solar cell 1 can always be used to charge the battery pack 3 with efficiency. Further, since the input voltage of the solar cell 1 is set by selecting one of the resistors 7e-7h, efficient charging can be achieved through a simple and inexpensive construction.

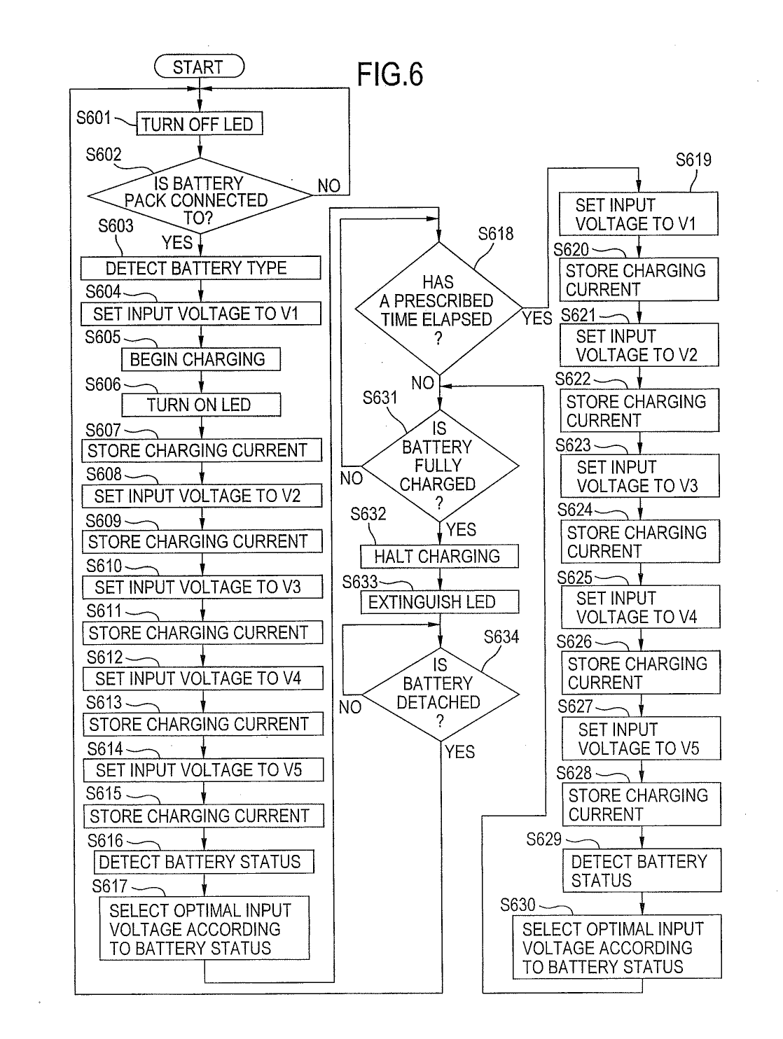

Next, a variation of the operations performed by the charging device according to the first embodiment will be described with reference to FIGS. 4, 6, and 7. FIG. 6 is a flowchart illustrating steps in the operations of the charging device. Since S601-S615, S618-S628, and S631-S634 in FIG. 6 are identical to S501-S515, S517-S527, and S529-S532 in FIG. 5, a detailed description of these steps will not be repeated.

Since the solar cell 1 supplies power to the auxiliary power supply 2, the auxiliary power supply 2 supplies power to the microcomputer 11 after the solar cell 1 is connected to the charging device 100, placing the microcomputer 11 in an operating state. In S601 of the flowchart in FIG. 6, the microcomputer 11 turns off the LED 14d to notify the user that charging is not being performed since a charging operation is not performed before the battery is connected. In S602 the microcomputer 11 determines whether the battery pack 3 has been connected to the charging device 100. In S603 the microcomputer 11 determines the type of battery based on a detection signal from the battery type discrimination circuit 4.

Before charging is initiated, in S604 the microcomputer 11 sets the input voltage to the first voltage setting V1. In S605 the microcomputer 11 then initiates charging and in S606 turns on the LED 14d of the charging status indicator circuit 14 to notify the user that charging has begun.

In S607 the microcomputer 11 detects the charging current when charging was started in S605 and stores this value. In S608 the microcomputer 11 sets the input voltage to the second voltage setting V2 and in S609 detects the charging current and stores this value. In S610 the microcomputer 11 sets the input voltage to the third voltage setting V3 and in S611 detects and stores the charging current. In S612 the microcomputer 11 sets the input voltage to the fourth voltage setting V4 and in S613 detects and stores the charging current. In S614 the microcomputer 11 sets the input voltage to the fifth voltage setting V5 and in S615 detects and stores the charging current.

Next, the microcomputer 11 finds the maximum allowed current of the battery pack 3 based on the battery voltage of the same and selects a maximum charging current from the values of charging current detected and stored in S607, S609, S611, S613, and S615 described above within a range that does not exceed this maximum allowed current. Then the microcomputer 11 sets the input voltage corresponding to this selected charging current as the input voltage for the charging device 100. Specifically, in S616 the microcomputer 11 detects the state of the battery, where the state of the battery indicates the type of battery, temperature of the battery, or the like.

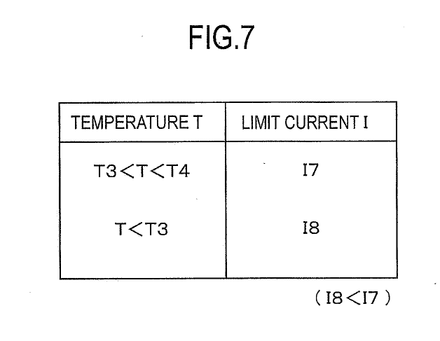

It is not desirable to supply a large current to a battery when the battery temperature is low. Therefore, the microcomputer 11 sets the maximum current to be supplied to the battery cells to a limit current I7 when a battery temperature T is higher than a temperature T3 (0° C., for example) and lower than a temperature T4 (40° C., for example) and sets the maximum current to a limit current I8 when the battery temperature T is lower than the temperature T3, as illustrated in FIG. 7. It should be noted that the limit current I8 is lower than the limit current I7. In other words, if any of the current levels detected in S607, S609, S611, S613, and S615 exceed the limit current set based on temperature, the microcomputer 11 selects the maximum current within a range that does not exceed the limit current. Next, in S617 the microcomputer 11 sets the input voltage corresponding to the selected current value as the input voltage of the charging device 100. By establishing limit currents for various battery temperatures in the battery pack 3, the charging device 100 can easily detect an output voltage from the solar cell having the maximum charging current that does not reduce or present danger to the battery performance.

In S618 the microcomputer 11 determines whether a prescribed time has elapsed since charging was begun. If the microcomputer 11 determines in S618 that the prescribed time has elapsed, then in S619-S628, as described earlier in S607-S616, the microcomputer 11 sequentially changes the input voltage to V1-V5, while detecting and storing the charging current at each input voltage. Next, in S629 the microcomputer 11 detects the battery status, such as the battery voltage and battery temperature, as described earlier in S616. In S630 the microcomputer 11 selects the maximum charging current from among those stored in the above steps within a range that does not exceed the maximum charging current determined according to the battery status, and sets the input voltage corresponding to the selected charging current as the input voltage for the charging device 100. By repeatedly executing the above process at fixed intervals, the charging device 100 can always charge the battery pack 3 efficiently with power from the solar cell 1.

Next, in S631 the microcomputer 11 determines whether the battery pack 3 is fully charged. If the microcomputer 11 determines in S631 that the battery pack 3 is fully charged, in S632 the microcomputer 11 halts the charging operation. However, if the microcomputer 11 determines in S631 that the battery pack 3 is not yet fully charged, the microcomputer 11 returns to S618. Once charging has been halted in S632, in S633 the microcomputer 11 turns off the LED 14d in the charging status indicator circuit 14 to notify the user that charging has ended. In S634 the microcomputer 11 determines whether the battery pack 3 has been detached from the charging device 100 and returns to S601 when the battery pack 3 has been detached.

As described above, the microcomputer 11 varies the input voltage at prescribed intervals while detecting and storing the charging current for each input voltage. Next, the microcomputer 11 selects the maximum charging current corresponding to the battery status from among the stored charging currents and sets the input voltage for the charging device 100 to the input voltage corresponding to the selected charging current. In this way, the charging device 100 can easily detect the operating voltage of the solar cell 1 at which the battery pack 3 can be most efficiently charged. Accordingly, the charging device 100 can efficiently charge the battery pack 3.

Further, the charging device 100 can charge the battery pack 3 at the maximum allowed current corresponding to the battery status. In other words, the charging device 100 can charge the battery pack 3 safely.

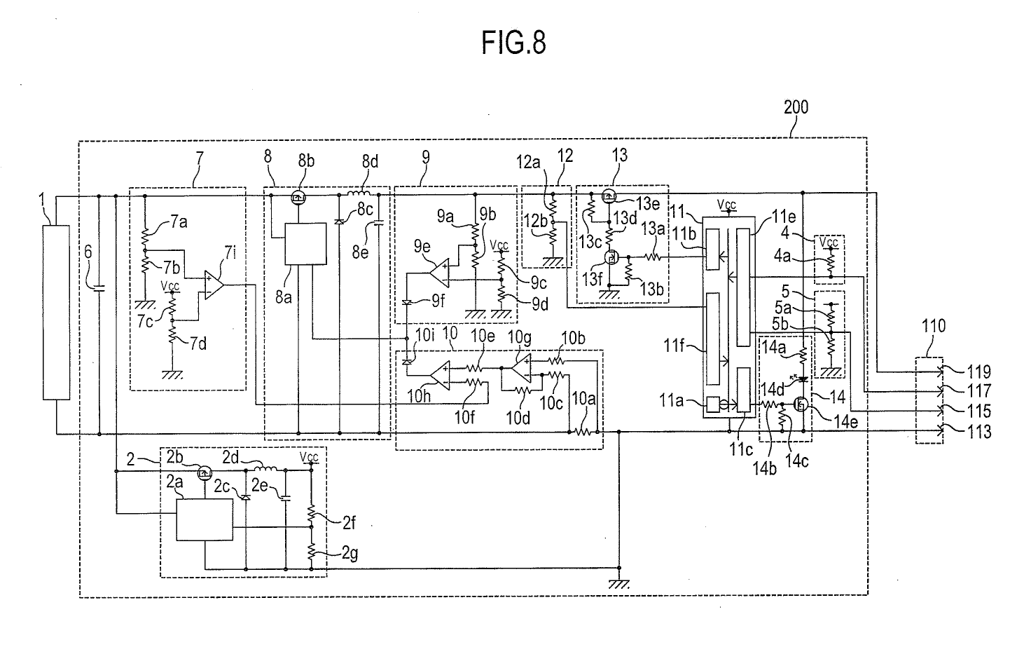

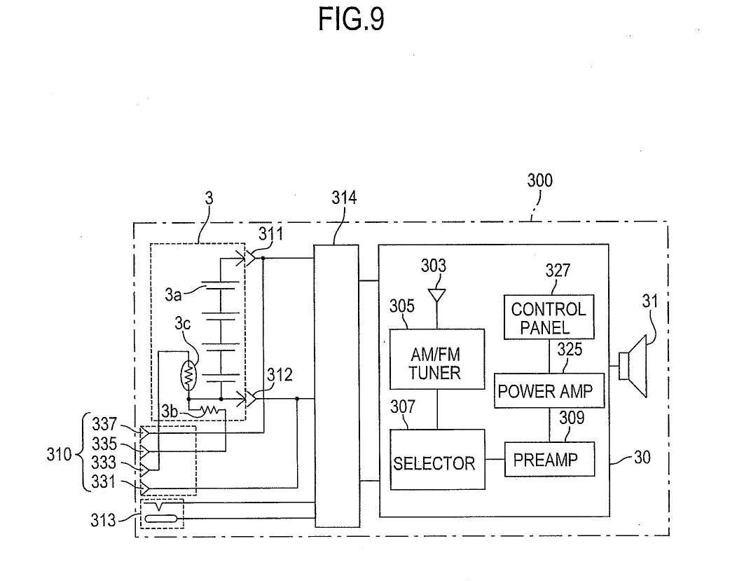

FIG. 8 shows a charging device 200 according to a second embodiment of the present invention. The charging device 200 is powered by the solar cell 1 and functions to charge a battery pack 3 built into a radio 300 shown in FIG. 9.

As shown in FIG. 9, the radio 300 includes a battery pack 3, a power supply circuit 314, a radio circuit 30, a speaker 31, an AC adapter input terminal 313 for receiving power supplied from a commercial power source, and a connector 310 for connecting the battery pack 3 to the charging device 200. The radio 300 operates based on power inputted via the battery pack 3 or the AC adapter input terminal 313. The connector 310 is configured of connection terminals 331, 333, 335, and 337. The battery pack 3 can be charged when connected to an external charging device via the connector 310.

The battery pack 3 includes a cell module 3a, a battery type discrimination resistor 3b, and a temperature-sensitive resistor 3c and is disposed so as to be connectable to the radio 300. In this embodiment, the cell module 3a is configured of four secondary battery cells connected in series and is connected between a positive terminal 311 and a negative terminal 312. The battery pack 3 can be charged by a charging device connected to the battery pack 3 when the positive side of the cell module 3a is connected to the terminal 337 of the connector 310 and the negative side is connected to the terminal 331. The battery type discrimination resistor 3b is connected between the negative side of the cell module 3a and the terminal 335 of the connector 310 and has a resistance value corresponding to the type and number of battery cells in the cell module 3a. The temperature-sensitive resistor 3c is connected between the negative terminal of the cell module 3a and the terminal 333 of the connector 310 at a point near the cell module 3a and serves as a temperature-sensitive element for detecting the battery temperature.

The power supply circuit 314 is connected to the battery pack 3 via the positive terminal 311 and negative terminal 312 and functions to convert the output voltage from the battery pack 3 to a voltage suited to operations of the radio circuit 30. For example, when the cell module 3a includes four lithium-ion batteries connected in series, as illustrated in FIG. 9, the battery pack 3 produces an output voltage of 3.6 V×4 (cells)=14.4 V. However, even when the output voltage of the battery pack 3 is different, such as 10.8 V for three cells connected in series or 17.2 V for two cells connected in series, the power supply circuit 314 converts this output voltage to a value suited for driving the radio circuit 30. Further, a battery pack having a different type of battery cells, such as nickel-cadmium batteries, may be used. In other words, the radio 300 can be powered by a plurality of types of battery cells having different output voltages.

The radio circuit 30 is a radio well known in the art that operates by power supplied from the power supply circuit 314. The radio circuit 30 includes an antenna 303, an AM/FM tuner 305, a selector 307, a preamp 309, a power amp 325, and a control panel 327. In response to operations performed on the control panel 327 of the radio circuit 30 having this construction, the antenna 303 receives radio waves, the AM/FM tuner 305 detects these radio waves, the selector 307 tunes in to a station, the preamp 309 adjusts the signal, the power amp 325 amplifies the signal and outputs the signal to the speaker 31, and the speaker 31 converts the inputted signal to sound.

As described above, the connector 310 provided in the radio 300 for connecting to an external charging device 200 is configured of terminals 331, 333, 335, and 337. The terminal 331 is connected to the negative side of the cell module 3a for inputting a reference potential. The terminal 333 is connected to the temperature-sensitive resistor 3c for outputting a signal corresponding to the temperature of the cell module 3a. The terminal 335 is connected to the battery type discrimination resistor 3b and functions as a battery pack identification terminal for outputting a signal corresponding to the type and output voltage of the battery cells. The terminal 337 is connected to the positive side of the cell module 3a that inputs electric power for charging the cell module 3a.

With the construction described above, the radio 300 receives power from the battery pack 3 that is built into the radio 300. The output voltage from the battery pack 3 is first converted to a voltage appropriate for operations of the radio circuit 30 by the power supply circuit 314 before being outputted to the radio circuit 30. The battery pack 3 of the radio 300 is also charged when connected to an external charging device via the connector 310. Although the radio 300 outputs information related to the battery pack 3 via the connector 310 during charging, the radio 300 has no circuit for performing charging. Further, in order to eliminate high-efficiency power supply switching, the radio 300 is not provided with a charging circuit powered by an AC adapter.

Next, the radio 300 and the charging device 200 provided for charging the battery pack 3 built into the radio 300 will be described.

As shown in FIG. 8, the charging device 200 is powered by the solar cell 1 and has an internal circuitry for regulating the output voltage from the solar cell 1 before outputting the voltage to an external connector 110. The connector 110 outputs this power for charging the battery pack 3. The charging device 200 is assembled as a single unit, for example. The charging device 200 is connected to the radio 300 described above via the connector 110 and the connector 310 and receives data related to the battery cells in the battery pack 3 for charging the same. Components in FIG. 8 similar to those in the construction shown in FIG. 4 are designated with the same reference numerals. Below, differences from the circuit shown in FIG. 4 will be described.

The connector 110 includes terminals 113, 115, 117, and 119. The connector 110 is connected to the connector 310 of the radio 300. The terminal 113 can be connected to the terminal 331 of the connector 310 for inputting a reference potential to the radio 300. The terminal 115 can be connected to the terminal 333 for receiving output from the temperature-sensitive resistor 3c. The terminal 117 can be connected to the terminal 335 for receiving a signal corresponding to the type and output voltage of the battery cells. The terminal 119 can be connected to the terminal 337 to form a charging path for charging the cell module 3a.

The input voltage feedback circuit 7 is configured of resisters 7a, 7b, 7c, and 7d; and an op-amp 7i. The resistors 7a and 7b are connected in series and divide the output voltage from the solar cell 1, with the resultant value being inputted into the noninverting input terminal of the op-amp 7i. The resistors 7c and 7d are also connected in series and divide the voltage Vcc, with the resultant value being inputted into the inverting input terminal of the op-amp 7i as a voltage setting for maintaining the input voltage at a prescribed value. The value obtained by dividing the output voltage of the solar cell 1 by the resistors 7a and 7b is controlled based on the output signal from the op-amp 7i so as to be equivalent to the voltage setting established by dividing the voltage Vcc with the resistors 7c and 7d. This voltage setting is established so as to output power approaching the maximum power received from the solar cell 1.

The charging on/off circuit 13 is configured of resistors 13a, 13b, 13c, and 13d; a P-channel FET 13e; and an N-channel FET 13f. The source of the P-channel FET 13e is connected to the output side of the power supply switching circuit 8, while the drain is connected to the terminal 119 of the connector 110. The gate of the P-channel FET 13e is connected to the drain of the N-channel FET 13f via the resistor 13d. The resistor 13c is connected between the source and gate of the P-channel FET 13e, and the resistor 13b is connected between the gate and source of the N-channel FET 13f. In order to perform a charging operation, the microcomputer 11 outputs a HIGH signal from the output port 11b to the resistor 13a, turning on the N-channel FET 13f. Turning on the N-channel FET 13f also turns on the P-channel FET 13e, establishing a connection between the charging device 200 and the cell module 3a through which a charging current can flow for charging the cell module 3a. To halt charging, the microcomputer 11 outputs a LOW signal from the output port 11b to the resistor 13a, turning off the N-channel FET 13f. Turning off the N-channel FET 13f also turns off the P-channel FET 13e, disconnecting the charging device 200 and cell module 3a to halt charging.

Next, the process performed by the charging device 200 for charging the battery pack 3 will be described with reference to FIGS. 8 through 10.

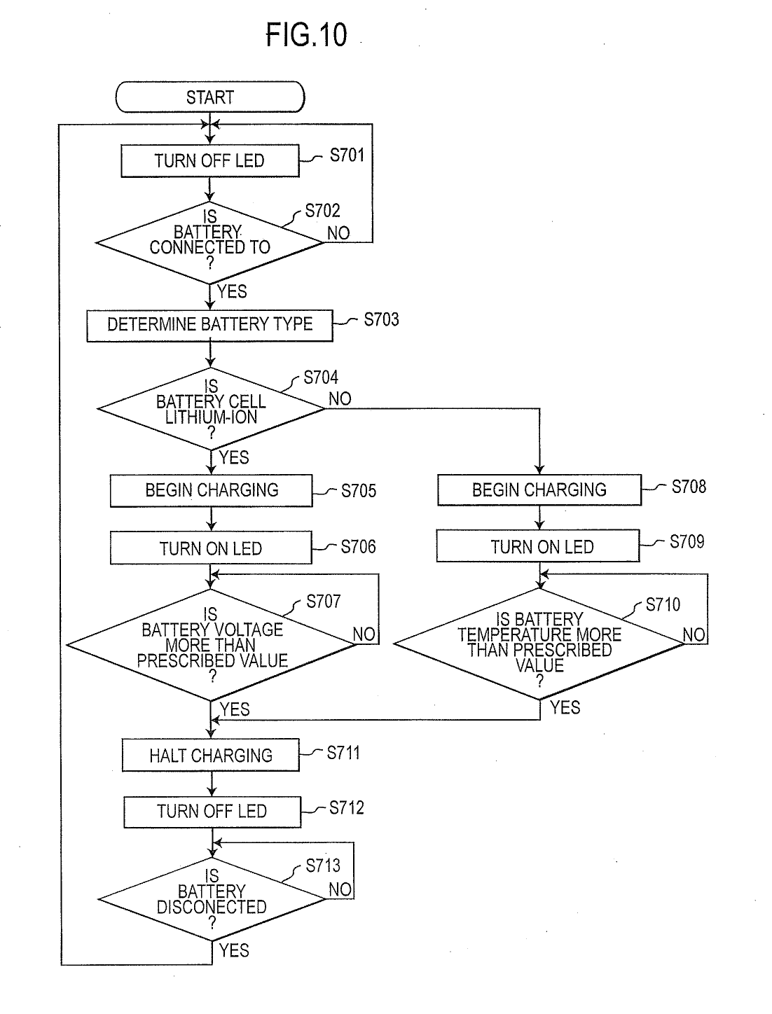

The process in FIG. 10 begins when the solar cell 1 is connected to the charging device 200, enabling the charging device 200 to begin operating with the solar cell 1 as a power supply. Prior to connecting the radio 300, in S701 the microcomputer 11 turns off the LED 14d to notify the user that the charging device 200 is not currently charging. In order to turn off the LED 14d, the microcomputer 11 outputs a LOW signal from the output port 11c of the microcomputer 11 to the resistor 14b, turning off the FET 14e. In S702 the microcomputer 11 determines whether the battery pack 3 has been connected to the charging device 200. The microcomputer 11 may make this determination based on a change in the detection signal from the battery type discrimination circuit 4 inputted in the A/D port 11e, for example. In S703 the microcomputer 11 determines the battery type based on the detection signal from the battery type discrimination circuit 4.

In S704 the microcomputer 11 determines whether the battery cells in the cell module 3a are lithium-ion batteries. If the battery cells are lithium-ion batteries, in S705 the microcomputer 11 begins charging. Specifically, the microcomputer 11 outputs a HIGH signal from the output port 11b to the cell module 3a, turning on the N-channel FET 13f and P-channel FET 13e and establishing a connection between the power supply switching circuit 8 and the battery pack 3 for charging. In S706 the microcomputer 11 turns on the LED 14d in the charging status indicator circuit 14 to notify the user that charging has begun. In order to turn on the LED 14d, the microcomputer 11 outputs a HIGH signal from the output port 11c to the resistor 14b, turning on the FET 14e.

In S707 the microcomputer 11 determines whether the battery voltage has reached a prescribed value in order to determine whether the battery pack 3 is fully charged. The microcomputer 11 detects the battery voltage based on a signal inputted from the battery voltage detection circuit 12 into the A/D port 11f. The microcomputer 11 continually repeats the determination in S707 while the battery voltage has not reached the prescribed value. The prescribed value of the battery voltage for determining when the battery pack 3 is fully charged is set based on the type of battery detected in S703. For example, when the battery cells are lithium-ion batteries, the prescribed value is set to 4.2 V per cell. Thus, the prescribed voltage is set to 4×4.2 V=16.8 V when four cells are connected in series, and 5×4.2 V=21 V when five cells are connected in series.

When the battery voltage has reached the prescribed value, in S711 the microcomputer 11 determines that the battery pack 3 is fully charged and ends the charging operation. The microcomputer 11 halts charging by outputting a LOW signal from the output port 11b to the resistor 13a, turning off the N-channel FET 13f and P-channel FET 13e and, hence, disconnecting the battery pack 3 from the power supply switching circuit 8.

However, if the microcomputer 11 determines in S704 that the battery cells are not lithium-ion batteries, in S708 the microcomputer 11 begins charging and in S709 turns on the LED 14d. Since the battery cells may be nickel-cadmium batteries or nickel-metal hydride batteries in this case, in S710 the microcomputer 11 determines whether the battery pack 3 is fully charged based on whether the battery temperature detected by the battery temperature detection circuit 5 has reached a prescribed temperature during the charging operation. When the microcomputer 11 determines in S710 that the battery temperature has reached this prescribed temperature, in S711 the microcomputer 11 determines that the battery pack 3 is fully charged and halts the charging operation.

After halting the charging operation in S711, in S712 the microcomputer 11 turns off the LED 14d of the charging status indicator circuit 14 in order to notify the user that charging has ended. To turn off the LED 14d, the microcomputer 11 outputs a LOW signal from the output port 11c to the resistor 14b, turning off the FET 14e. In S713 the microcomputer 11 determines whether the battery pack 3 has been detached from the charging device 200 and returns to S701 when the battery pack 3 has been detached.

In the second embodiment described above, the radio 300 is not provided with a circuit for controlling charging of the battery pack 3. The battery pack 3 in the radio 300 can be charged by connecting the charging device 200 to the connector 310 of the radio 300, whereby the charging device 200 supplies power and controls the charging operation. Further, by not providing a built-in charging circuit in the radio 300, it is possible to manufacture a radio 300 that is lighter and less expensive to produce and that generates less noise.

In addition, the charging device 200 determines the type of batteries in the battery pack 3 built into the radio 300 and halts the charging operation upon detecting that the battery pack 3 is fully charged based on a method corresponding to the type of battery. Hence, the charging device 200 can safely charge the battery pack 3 built into the radio 300 using the solar cell 1 as a power supply, even when the type of batteries provided in the radio 300 is unknown. Hence, the user can use the charging device 200 without worrying about the type and output voltage of the battery pack 3.

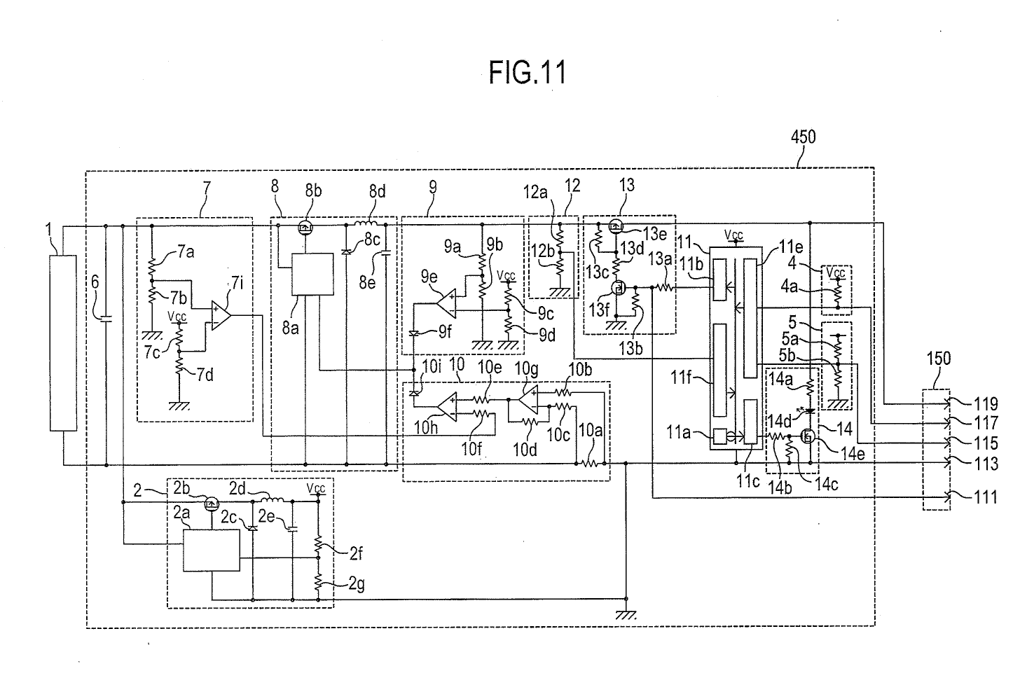

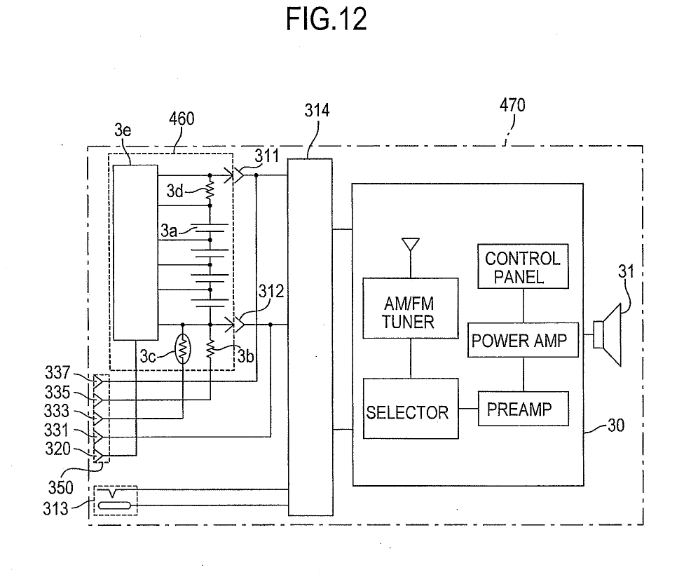

Next, a variation of the charging device and radio shown in FIG. 8 will be described with reference to FIGS. 11 and 12, where like parts and components are designated with the same reference numerals to avoid duplicating description.

In the variation of the second embodiment shown in FIGS. 11 and 12, a charging device 450 charges a battery pack 460 built into a radio 470.

The radio 470 includes the radio circuit 30, the power supply circuit 314, the detachably mounted battery pack 460, and a connector 350 for connecting the battery pack 460 to the charging device 450. In addition to the terminals 331, 333, and 335 provided in the connector 310 according to the second embodiment, the connector 350 includes a terminal 320 for outputting a signal received from a protection circuit 3e described next.

Further, in addition to the construction of the battery pack 3 shown in FIG. 9, the battery pack 460 includes the protection circuit 3e, and a current sensing resistor 3d. In this embodiment, the protection circuit 3e monitors the battery voltage of each of the cells connected in series in the cell module 3a. The protection circuit 3e outputs a charge halting signal via the terminal 320 when the output voltage of any cell exceeds a prescribed voltage. Further, the protection circuit 3e outputs a charge halting signal via the terminal 320 when the current sensing resistor 3d detects a current larger than a prescribed current.

The charging device 450 is assembled as a single unit, for example, and includes the solar cell 1, and circuitry for outputting power to an external connector 150. In addition to the structure of the connector 110 shown in FIG. 8, the connector 150 includes a terminal 111 for transferring the charge halting signal from the protection circuit 3e. The terminal 111 is connected to the gate of the N-channel FET 13f in the charging on/off circuit 13. When a charge halting signal is inputted into the terminal 111, the microcomputer 11 halts charging by turning off the N-channel FET 13f and P-channel FET 13e in the charging on/off circuit 13 to disconnect the battery pack 460 from the power supply switching circuit 8.

With this construction, the charging device 450 detects an overcharge, overcurrent, or the like in the battery pack 460 and controls charging based on this data.

As described in the second embodiment, the radio 470 eliminates all circuitry related to charging the battery pack 460. The charging device 450 connected to the connector 350 supplies power to and controls the charging of the battery pack 460 mounted in the radio 470. By not providing a built-in charging circuit in the radio 470, it is possible to produce a radio 470 that is lighter and less expensive and that produces less noise.

Further, the charging device 450 determines the type of battery cells in the battery pack 460 built into the radio 470 and uses a method suitable for this battery type to detect when the battery pack 460 is fully charged and, thus, when to halt charging.

The protection circuit 3e detects overcurrent and overcharge in the battery pack 460 and outputs a charge halting signal through the terminal 320. The charging device 450 halts charging upon detecting this signal. Hence, the charging device 450 powered by the solar cell 1 can safely charge the battery pack 460 built in the radio 470, even when the type of batteries provided in the radio 470 is unknown. Accordingly, the user can use the charging device 450 without worrying about the type and output voltage of the battery pack 460.

While the charging device according to the invention has been described in detail with reference to specific embodiments thereof, it would be apparent to those skilled in the art that many modifications and variations may be made therein without departing from the spirit of the invention, the scope of which is defined by the attached claims. For example, the circuitry of the charging device according to this embodiment may have a different configuration from that described in the above embodiments, provided that the charging device can achieve the same operations and effects.

Further, the charging device determines when the battery pack is fully charged based on when the battery voltage or battery temperature exceeds a corresponding prescribed value, but the present invention is not limited to this method of detection. Further, while the present invention is applied to a radio in the second embodiment, the present invention may be applied to another electronic device such as a CD player or other music player, and a television or other image-displaying device. The secondary batteries provided in the battery pack are also not limited to the types described in the embodiments.

According to the present invention, battery data related to the battery pack built into the electronic device is transmitted to the charging device so that the charging device can perform suitable charging based on this battery data.

The solar-powered charging device according to the present invention can detect data related to battery cells provided in an electronic device. Since the battery charger controls charging based on this detected data, the charger can perform charging suitable to the type of battery provided in the electronic device, the connection state, and the like. Hence, the charging device according to the present invention can charge a battery pack efficiently through a simple construction using power outputted from a solar cell.

The charging device according to the present invention can charge a battery pack at a voltage setting within an allowable range for the voltage of the battery pack while the solar cell constantly outputs a maximum power, regardless of other conditions such as the irradiance of sunlight.

The charging device according to the present invention can maximize use of the output power produced by the solar cell.

Specifically, the charging device according to the present invention sets the charging voltage so as to obtain maximum output voltage from the solar cell within a range that does not exceed a maximum charging current suited to the type of secondary battery cell being charged, the connection state of the cells, the temperature of the cells, or the like.

Through a simple construction, the charging device of the present invention can easily identify an output voltage that maximizes the output power received from the solar cell.

What is claimed is:

1. A solar power system, comprising:
a charging device powered by a solar cell to charge a battery pack having a secondary cell, the charging device comprising:
input voltage detection circuit that detects an input voltage from the solar cell;
switching circuit that converts the input voltage to supply a charging current to the battery pack;
charging current detection circuit that detects the charging current; and
control circuit that controls the switching circuit to change the input voltage in order that a resultant charging current becomes suitable for charging the battery pack.

2. The solar power system as claimed in claim 1, further comprising an electric instrument, wherein
the charging device charges a plurality of types of battery packs, each of the plurality of types of batter packs having a secondary cell and information output circuit that generates battery information related to the secondary cell,
the electric instrument is detachably connected to and powered by one of the plurality of types of battery packs, and
the charging device further comprises information reception circuit that receives the battery information related to the one of the plurality of types of battery packs to be charged; and
the control circuit controls charging the one of the plurality of types of battery packs connected to the electric instrument, based on the received battery information.

3. The solar power system as claimed in claim 1, wherein the charging device further comprises:
charging voltage detection circuit that detects a charging voltage across the battery pack; and
input voltage changing circuit that changes the input voltage to one of a plurality of different voltage values, the charging current being detected by the charging current detection circuit every time the input voltage is changed;
maximum allowed current calculation circuit that calculates a maximum allowed current value according to the charging voltage detected by the charging voltage detection circuit;
input voltage selection circuit that selects a voltage value among the plurality of different voltage values as the input voltage, the selected voltage value corresponding to a detected maximum charging current which does not exceed the maximum allowed current value, and
renewing circuit that renews the input voltage at intervals to charge the battery pack.

4. The solar power system as claimed in claim 3, wherein the input voltage setting circuit comprises a plurality of resisters, each of the plurality of resistors having a different resistance to each other.

5. The solar power system as claimed in claim 3, wherein the charging device further comprises:
battery cell condition detection circuit that detects a cell condition of the secondary cell in the battery pack; and
maximum charging current calculation circuit that calculates a maximum charging current according to the detected cell condition by the battery cell condition detection circuit, wherein
the input voltage selection circuit sets the input voltage to a voltage corresponding to a current which does not exceed the maximum charging current.
